(19) United States
(12) Patent Application Publication
(10) Pub. No.: US 2003/0189937 A1
(43) Pub. Date: Oct. 9, 2003

(54) Address search method and search system using the same

(76) Inventor: Takeshi Kawasaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/378,387

(22) Filed: Mar. 3, 2003

(30) Foreign Application Priority Data
Apr. 3, 2002 (JP) 2002-101166

(51) Int. Cl. H04L 12/28

(52) U.S. Cl. 370/395.32; 370/428

(57) ABSTRACT

A fast masked search for data having arbitrary length can be achieved using a plurality of fixed-length masked search function sections by a packet address search method, which includes the steps of dividing a search field in a packet into a plurality of sub-fields each being searchable at one time; performing a masked search for a match with each sub-field, and obtaining matched sub-entry identifiers as a primary search; generating a combination of the plurality of sub-entry identifiers obtained by the primary search; and performing a search for a match with the combination of the plurality of sub-entry identifiers and obtaining an entry identifier as a secondary search.

### FIELD OF THE INVENTION

The present invention relates to a network address search system and more particularly a network address search system performing a search for a match with a packet format pattern.

### BACKGROUND OF THE INVENTION

In packet transmission used in a network particularly in the Internet, it has been required in recent years to perform filtering control or access control against a packet on a basis of application or contents in a WWW server.

To fulfill this requirement, it has been required for a packet transfer unit, a packet processing unit, or the like, to identify not only address information but a pattern up to an upper packet field at high speed, and to determine an appropriate route or process against the packet of interest.

For this purpose, there has been required a field-match search using an arbitrary field in a packet or using a bit mask. As one method of a search for a match, an algorithm employing a tree structure has been used. As an alternative method, a high-speed search method using a hardware device called CAM (Content Addressable Memory) has been developed, in which bit mask patterns are used to search a match on an incoming packet-by-packet (or a packet entry) basis.

However, there is a problem of complicated processing when using the tree structure algorithm, which impedes a high-speed search. Also, another problem is that the mask must be fixed at either the top or bottom position to achieve a high-speed search.

Further, in the search method using CAM, there is a problem that a field bit length has a limit because of technical limitation in the device production.

### SUMMARY OF THE INVENTION

Accordingly, in consideration of the above-mentioned problems, it is an object of the present invention to provide an address search method which enables to perform a high-speed search using a mask of arbitrary length.

The concept of the present invention to solve the above-mentioned problems is to provide a primary search function section. In this primary search function section, a packet search field is divided into a plurality of sub-fields, and a primary search using a mask is performed, searching for a match with each sub-field. Thus corresponding sub-entry identifiers are obtained. Hereafter, a search using a mask is referred to as a masked search.

Further, according to the present invention, a secondary search function section is provided, in which an entry identifier is obtained by a search for a match with the combination of sub-entry identifiers obtained in the primary search function section.

More specifically, first, fields to be searched for a match are extracted from an object packet for processing. Next, a plurality of search keys corresponding to the combinations of the extracted fields are generated. Using these search keys, sub-entry identifiers are obtained in the primary search function section.

Thereafter, another search key is generated by combining sub-entry identifiers obtained in the above procedure, which is forwarded to the secondary search function section. In the secondary search function section, an entry identifier which corresponds to the processing against the packet of interest is obtained. According to the entry identifier obtained in the secondary search function section, the packet can be transferred or processed for access permission.

According to the present invention, a packet field for use in a search for a match is divided into a plurality of field sets (sub-fields). The field sets are transferred to the primary search function section. Using masked search function sections provided with masks of fixed field length, it becomes possible to configure a masked search mechanism which is capable of searching for a data having an arbitrary length.

As a first aspect of the packet address search method according to the present invention, the method includes the steps of; dividing a search field in a packet into a plurality of sub-fields each being searchable at one time; performing a masked search for a match with each sub-field, and obtaining matched sub-entry identifiers as a primary search; generating a combination of the plurality of sub-entry identifiers obtained by the primary search; and performing a search for a match with, the combination of the plurality of sub-entry identifiers and obtaining an entry identifier as a secondary search.

As a second aspect of the packet address search method according to the present invention, the method includes the steps of; performing a masked search for a match with each sub-field searchable at one time in a packet search field; obtaining matched sub-entry identifiers as a primary search; performing a masked search for a match with a combination of both the sub-entry identifiers obtained in the primary search and at least a remainder portion of the packet search field, and obtaining an entry identifier as a secondary search.

As a third aspect of the packet address search method, in the first or second aspect of the present invention, when an inclusion relation exists between each field in the primary search, like sub-entry identifiers are set in advance so as to obtain a match with each field having the inclusion relation in the masked search.

As a fourth aspect of the packet address search method, in the first or second aspect of the present invention, when an inclusion relation exists between each field in the primary search, sub-entry identifiers are set in advance so that one sub-entry identifier of an entry having the inclusion relation can be obtained from another sub-entry identifier obtained in the masked search. In the secondary search, a search for a match with the entire combinations of sub-entry identifiers.

As a fifth aspect of the packet address search method, in the second aspect of the present invention, in the primary search, a masked search is performed, searching for a match with source session information consisting of a combination of an IP source address and a TCP/UDP source port number as a packet search field. In the secondary search, a masked search is performed, searching for a match with the sub-entry identifier obtained from the primary search function section and destination session information consisting of a combination of the remainder fields including an IP destination address, an IP protocol and a TCP/UDP destination port number.

As a sixth aspect of the packet address search method, in the first or second aspect of the present invention, when an inclusion relation exists between each field in the primary search, sub-entry identifiers are set in advance so that one sub-identifier of an including entry can be obtained from the other included entry. A matched entry identifier is obtained by a search for a match with the entire combinations of the obtained sub-entry identifiers.

As a seventh aspect of the packet address search method, in the sixth aspect of the present invention, when a field set having no relation with the entry exists, the entry is set in the primary search for a sub-entry identifier so as to mask the field set.

Further scopes and features of the present invention will become more apparent by the following description of the embodiments with the accompanied drawings.

### BRIEF DESCRIPTION OF THE DRAWINGS

FIG. 1 is a diagram illustrating a configuration example of a packet processing unit to which the method of the present invention is applied.

FIG. 2 is a diagram illustrating a first embodiment of a primary search function section 21 and a secondary search function section 22 incorporated in the packet processing unit shown in FIG. 1.

FIG. 3 is a flowchart (part 1) illustrating the processing in primary search function section 21 shown in FIG. 2.

FIG. 4 is a flowchart (part 2) illustrating the processing in primary search function section 21 shown in FIG. 2.

FIG. 5 is a flowchart (part 3) illustrating the processing in primary search function section 21 shown in FIG. 2.

FIG. 6 is a diagram illustrating an embodiment example of the operation performed in primary search function section 21 and secondary search function section 22 in the first embodiment of the present invention.

FIG. 7 is a diagram illustrating the header information setting of a packet which is to be either discarded or transmitted when the first embodiment is incorporated in a packet transfer unit.

FIG. 8 is a diagram illustrating another embodiment example of the operation performed in primary search function section 21 and secondary search function section 22 in the first embodiment of the present invention.

FIG. 9 shows an embodiment of primary search function section 21 and secondary search function section 22 in a second embodiment to which the method of the present invention is applied.

FIG. 10 is a diagram illustrating an example of settings for the incoming packet processing in the second embodiment of the present invention.

FIG. 11 shows another embodiment of primary search function section 21 and secondary search function section 22 in the second embodiment to which the method of the present invention is applied.

FIG. 12 shows still another embodiment of primary search function section 21 and secondary search function section 22 in a third embodiment of the present invention, in which a search function for layer 4 (L4) load balancing is introduced.

FIG. 13 is a diagram illustrating an example of setting a search entry in the third embodiment shown in FIG. 12.

FIG. 14 is a diagram illustrating a configuration example of primary search function section 21 and secondary search function section 22, in the case that a destination port number in the destination session information is different from that shown in FIG. 12, though the source session information is identical.

FIG. 15 is a diagram illustrating a configuration example of primary search function section 21 and secondary search function section 22, in the case that an IP protocol in the destination session information is different from that shown in FIGS. 12 and 14, though the source session information is identical.

### DETAILED DESCRIPTION OF THE PREFERRED EMBODIMENTS

The preferred embodiment of the present invention is described hereinafter referring to the charts and drawings.

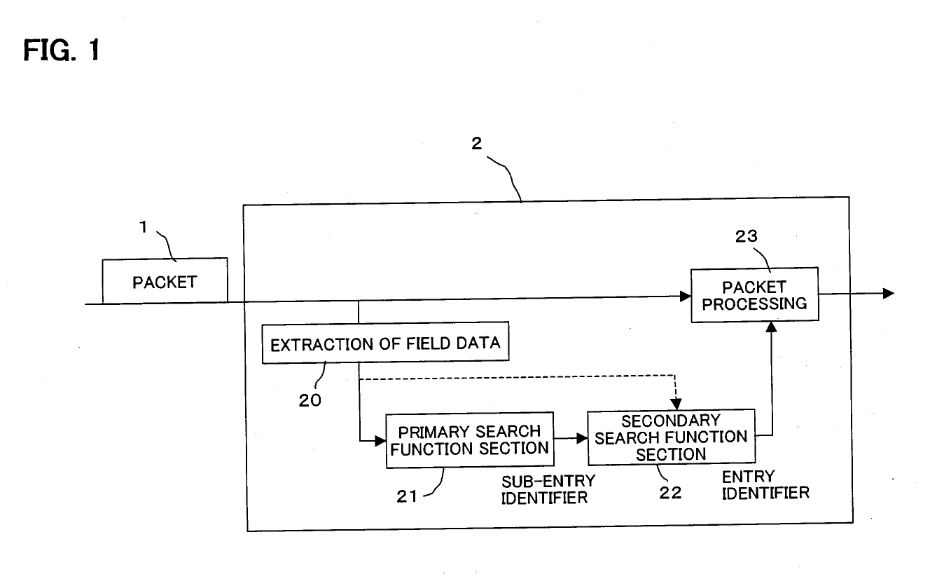

FIG. 1 shows a configuration example of a packet processing unit to which the method of the present invention is applied. Such a packet processing unit may function as packet transfer unit, firewall equipment, router, etc. in a network.

When a packet 1 is incoming to a packet processing unit 2, a predetermined field data are extracted for searching in a field data extraction section 20. According to the present invention, sub-entry identifiers are obtained in a primary search function section 21 based on the field data extracted in field data extraction section 20. An entry identifier is then obtained in a secondary search function section 22 based on the sub-entry identifiers obtained in primary search function section 21.

Thereafter, based on the entry identifier obtained in secondary search function section 22, an appropriate process corresponding to functions provided in packet processing unit 2 is performed in a packet processor 23. For example, when packet processing unit 2 functions as a packet transfer unit, packets specified to transmit by the entry identifier are transmitted from packet processor 23, while other packets are discarded.

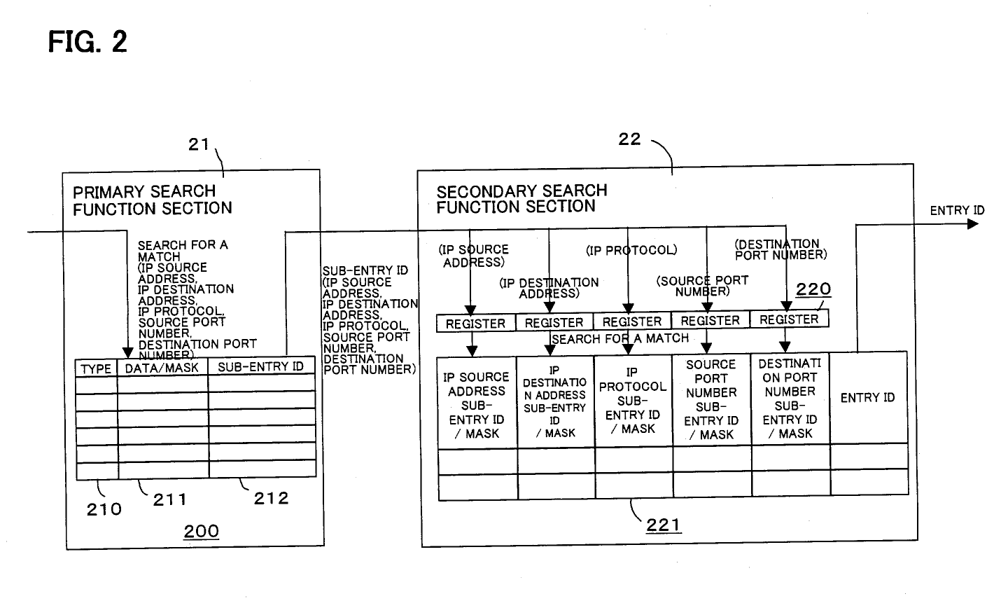

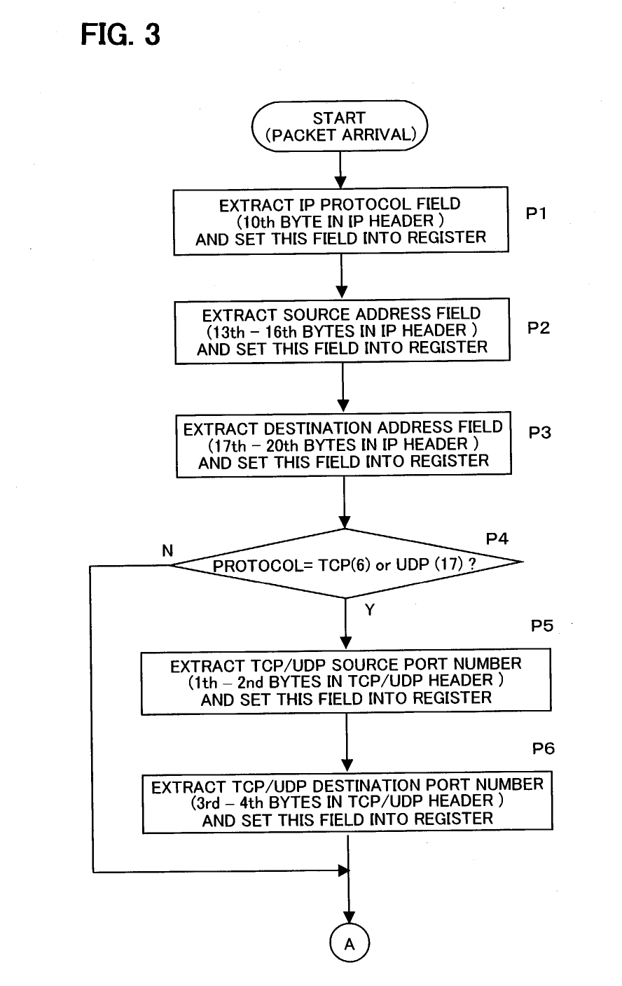

FIG. 2 shows a first embodiment of primary search function section 21 and secondary search function section 22. In FIGS. 3 through 5, the flowcharts illustrate the processing to be carried out in primary search function section 21 shown in FIG. 2. Using these charts, an exemplary search function which performs the L4 (Layer 4) filtering in accordance with the present invention will be described hereafter.

Here, an IP (Internet Protocol) packet includes an IP header specified by the IETF (Internet Engineering Task Force), as well as a TCP (Transmission Control Protocol) header or a UDP (User Datagram Protocol) header.

The IP header includes an IP source address, an IP destination address and an IP protocol, while the TCP or UDP (hereinafter referred to as TCP/UDP) header includes a TCP/UDP source port number and a TCP/UDP destination port number.

In the packet processing unit, it is set in advance how to process each packet specified by these IP header and TCP/UDP header. For example, when the packet processing unit is used as a packet transfer unit, whether the specified packet should be discarded or transmitted is set.

In FIG. 2, primary search function section 21 is constituted of a table 200, which includes a plurality of sub-fields. In this table 200, a type 210, a masked data 211 and a sub-entry identifier (ID) 212 have been registered for each sub-field.

Type 210 indicates the type of each packet header item. Namely, ‘SA’ shows IP source address, ‘DA’ shows IP destination address, ‘Pro’ shows IP protocol, ‘SP’ shows TCP/UDP source port number, and ‘DP’ shows TCP/UDP destination port number.

Contents of the header are registered in masked data 211, corresponding to each type indication. Each sub-entry identifier 212 is assigned in advance corresponding to each registered header item. Sub-entry identifier 212 is for use in secondary search function section 22 as a search key.

As outputs of primary search function section 21, five sub-entry identifiers 212 are obtained, each corresponding to IP source address (SA), IP destination address (DA), IP protocol (Pro), TCP/UDP source port number (SP), or TCP/UDP destination port number (DP).

Further, referring to FIG. 2, registers 220 are provided in secondary search function section 22. Each sub-entry identifier 212 obtained from primary search function section 21 is set into each register 220. Based on sub-entry identifier 212 having been set in register 220, a search for a match with each corresponding entry value registered in table 221 is performed, and thus an entry identifier is obtained.

Now, a processing operation of primary search function section 21 shown in FIGS. 1, 2 is described hereafter referring to FIGS. 3 through 5.

In FIG. 1, when packet 1 to be processed reaches packet processing unit 2, field data extraction section 20 in packet processing unit 2 extracts the IP packet protocol field (i.e. the 10th byte in the IP header) in the packet of interest, and then stores the extracted field into a non-illustrated register (procedure P1).

In a similar way, field data extraction section 20 extracts the IP source address field (4 bytes in the 13th-16th byte of the IP header) and stores the extracted address field into the register (procedure P2). Field data extraction section 20 also extracts the IP destination address field (4 bytes in the 17th byte through the 20th byte of the IP header) and stores the extracted address field into the register (procedure P3).

Further, it is determined from the extracted IP protocol field whether the protocol being in use is TCP or UDP. When the protocol is neither TCP nor UDP, extraction from the TCP/UDP header is not performed (‘N’ in procedure P4).

On the other hand, if the protocol is either TCP or UDP (‘Y’ in procedure P4), field data extraction section 20 extracts the TCP/UDP port source number field in the TCP/UDP header (that is, 2 bytes in the 1st byte and the 2nd byte of the TCP/UDP header) and stores the extracted data into the register (procedure P5).

In a similar way, field data extraction section 20 extracts the TCP/UDP port destination number field in the TCP/UDP header (2 bytes in the 3rd-4th byte of the TCP/UDP header) and stores the extracted data into the register (procedure P6).

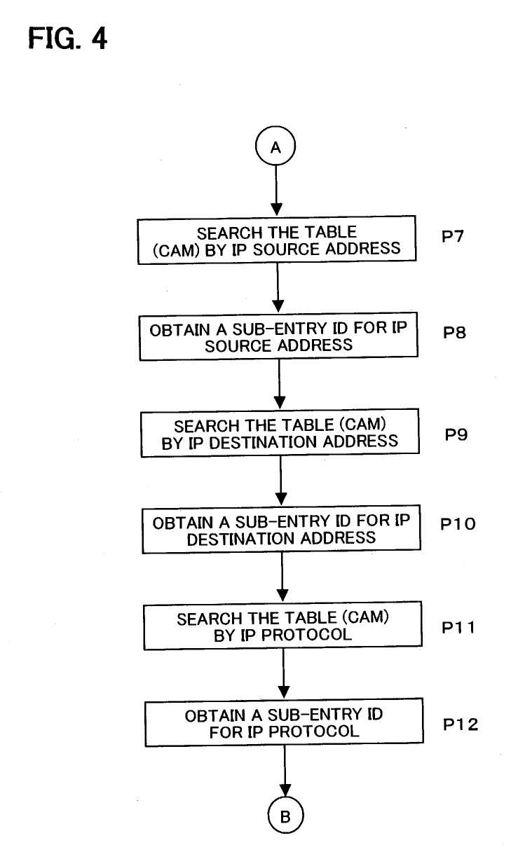

Thereafter, the process proceeds to the flow shown in FIG. 4, in which field data extraction section 20 searches the table (CAM) 200 based on the extracted IP source address (procedure P7). More specifically, the table 200 is searched for a data matching the extracted IP source address from among data with a mask (hereinafter referred to as masked data or simply ‘data/mask’) having the item indication SA which represents IP source address. Thus a sub-entry identifier (ID) for the IP source address corresponding to the matched data/mask is obtained (procedure P8).

In a similar way, table 200 is searched based on the extracted IP destination address (procedure P9), and a sub-entry identifier (ID) for the IP destination address corresponding to the matched data/mask is obtained (procedure P10). Also, through the table search based on the extracted IP protocol (procedure P11), sub-entry identifier for the IP protocol is obtained (procedure P12).

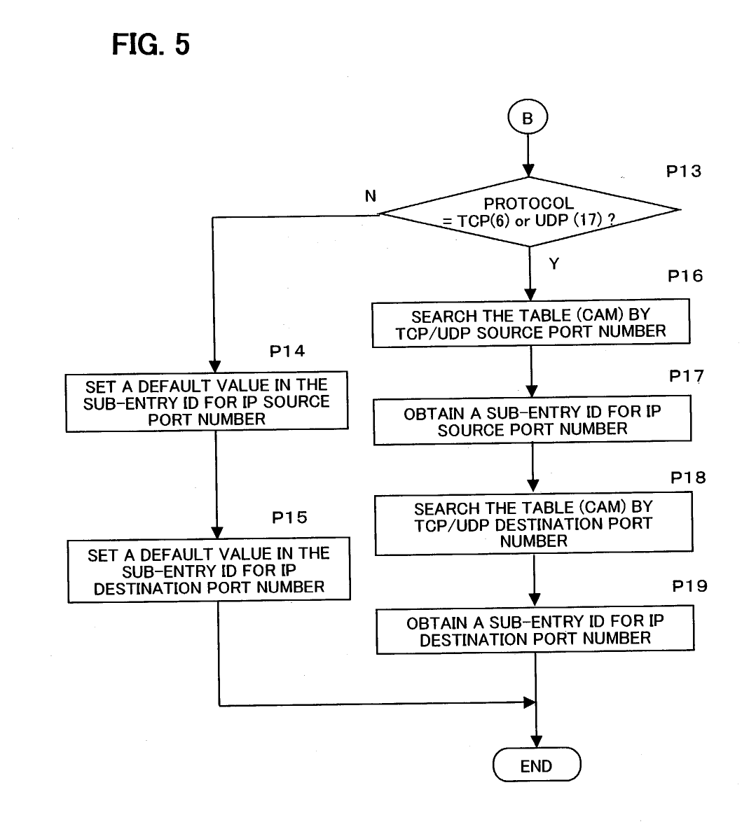

Thereafter, the process proceeds to the flow shown in FIG. 5. When the protocol is neither TCP nor UDP (‘N’ in procedure P13), a default value is set as a sub-entry identifier for the IP source port number (procedure P14) and also a default value is set as a sub-entry identifier for the IP destination port number (procedure P15).

Meanwhile, when the protocol is either TCP or UDP (‘Y’ in procedure P13), the table is searched based on the extracted TCP/UDP source port number (procedure P16), and a sub-entry identifier for the IP source port number is obtained (procedure P17).

Similarly, the table is searched based on the extracted TCP/UDP destination port number (procedure P18), and a sub-entry identifier for the IP destination port number is obtained (procedure P19).

In such a way, the data extracted in field data extraction section 20 and stored into the register is identified whether this data matches any data/mask registered in the table in primary search function section 21 on an item type-by-type basis, namely, IP source address (SA), IP destination address (DA), IP protocol (Pro), TCP/UDP source port number (SP) and TCP/UDP destination port number (DP). Thus each sub-entry identifier 212 corresponding to the matched data is obtained.

Next, in secondary search function section 22, a search is performed, searching for a match with a combination of sub-entry identifiers obtained in the primary search. As a result, an entry identifier is obtained and the entry identifier is forwarded to packet processor 23.

More specifically, in secondary search function section 22, there is provided a register 220 in which each sub-entry identifier obtained in the primary search is set. In secondary search function section 22, table 221 is searched using the contents set in register 220 as a search key. Through this search operation, an entry identifier corresponding to the matched combination set in advance in table 221 is output.

Hereafter the details of the present invention will be described using examples set in the tables in primary search function section 21 and secondary search function section 22.

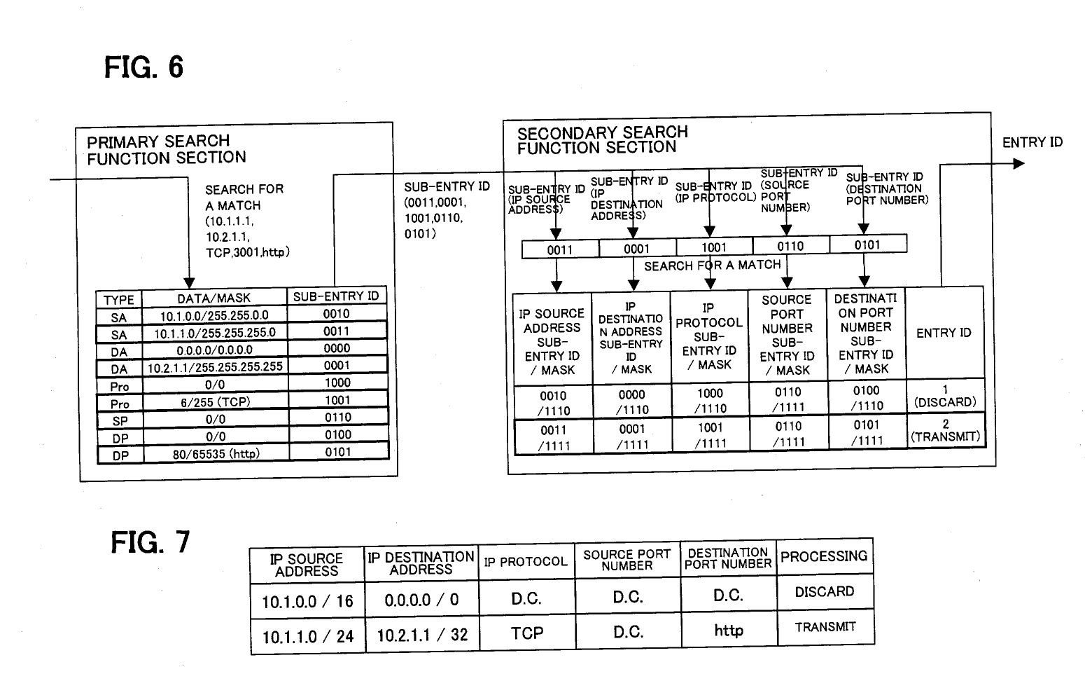

FIG. 6 shows a first embodiment of primary search function section 21 and secondary search function section 22 shown in FIG. 2 according to the first embodiment of the present invention. The tables shown in FIG. 6 contain header information of a packet to be either discarded or transmitted as shown in FIG. 7 when packet processing unit 2 functions as a packet transfer unit.

Namely, in FIG. 7, when IP source address SA is 10.1.0.0/16, IP destination address DA is 0.0.0.0/0, while IP protocol Pro, source port number SP and destination port number DP take arbitrary values D.C. (don't care), it is indicated that discard processing should be performed against the packet of interest. Also, when IP source address SA is 10.1.1.0/24, IP destination address DA is 10.2.1.1/32, IP protocol Pro is TCP, source port number SP takes an arbitrary value D.C. (don't care), and destination port number DP is ‘http’, it is indicated that transmission processing should be performed.

Corresponding to these settings shown in FIG. 7, combinations of types and data/masks are registered in advance in table 200 of primary search function section 21 in the embodiment shown in FIG. 6.

Here, as for the masks in the data/mask 211 corresponding to the item SA in type 210 of table 200, for example the representation of ‘/16’ in FIG. 7 is shown as ‘/255.255.0.0’ in FIG. 6. Because ‘255’ signifies the entire 8 bits are logical ones, ‘/255.255.0.0’ denotes the mask having 16 bits of contiguous ones, which may be represented as ‘/16’.

Now, in the example shown in FIG. 6, it is assumed that header data having the following values are extracted from an entry packet: IP source address SA is 10.1.1.1, IP destination address DA is 10.2.1.1, IP protocol Pro is TCP, source port number SP is 3001, and destination port number DP is ‘http’.

Here, in the table of primary search function section 21 shown in FIG. 6, data/masks 211 and sub-entry identifiers 212 are registered on a sub-field basis corresponding to type 210, based on the settings shown in FIG. 7.

As the way of mask setting, for example, 10.1.0.0/255.255.0.0 is represented in FIG. 6, as contrasted with ‘10.1.0.0/16’ shown in FIG. 7. As mentioned earlier, because 255 signifies the entire bits of logical ‘1’ in one byte, ‘/255.255.0.0’ means the same as ‘/16’.

Now as an example, it is assumed that the IP source address, the IP destination address, the IP protocol, the source port number and the destination port number respectively have the following values in the contents of the search fields extracted from the incoming packet header:

IP source address: 10.1.1.1

IP destination address: 10.2.1.1

IP protocol: TCP

Source port number: 3001

Destination port number: http

The IP source address 10.1.1.0/255.255.255.0 which is set in table 200 of FIG. 6 according to the settings shown in FIG. 7 is included in the IP source address 10.1.0.0/255.255.0 which is also set in table 200. Therefore, the aforementioned IP source address 10.1.1.1 in the incoming packet matches both IP source address data registered in table 200.

In such a case that the address in the incoming packet matches both addresses registered in table 200, a sub-entry identifier corresponding to the IP source address having a mask of the longest length is selected (sub-entry ID=0011 in the example shown in FIG. 6) as a result of the search.

For IP source address not having the longest mask length, a sub-entry identifier, for example 0010, is assigned so that a certain range of upper bits in the sub-entry identifier have common values to the corresponding values of the sub-entry identifier for the IP source address having the longest mask length.

As for the example of the IP destination address 10.2.1.1 in the incoming packet, because this matches 10.2.1.1/255.255.255.255, the corresponding sub-entry identifier 0001 is obtained.

As for IP protocol of the incoming packet, 6/255 (TCP) has priority among the matched results. Therefore the corresponding sub-entry identifier 1001 is obtained. Also, the source port number matches 0/0 (D.C.) and the destination port number matches 80/65535 (http). Thus the corresponding sub-entry identifiers 0110 and 0101 are obtained respectively.

Next, in such a manner as described above, a set of sub-entry identifiers obtained from primary search function section 21 is set into register 220 in secondary search function section 22.

Meanwhile, in table 221 of secondary search function section 22, entry identifiers are set on a type-by-type basis corresponding to the sub-entry identifiers with a mask provided for each sub-entry identifier. Here, the masks applied thereto have configurations, as well as implication, which are identical to those applied in primary search function section 21.

For example, in primary search function section 21, the second SA data (10.1.1.0/255.255.255.0) is included in the first SA data (10.1.0.0/255.255.0.0). As a result, the sub-entry identifier corresponding to the second SA data is set as 0011, as contrasted with the sub-entry identifier 0010 corresponding to the first SA data.

Corresponding to the above settings, also in secondary search function section 22, the mask for the first sub-entry identifier is set as 1110, so that the second sub-entry identifier 0011 be included in the first sub-entry identifier 0010. This enables to match not only the second SA data but also the first SA data when the second sub-entry identifier 0011 is given in the secondary search.

In the example shown in FIG. 6, table 221 of secondary search function section 22 is searched and the search results in matching the entry identifier ‘2’, which indicates the packet of interest to be an object for transmission processing. More specifically, when the IP source address of the incoming packet is 10.1.1.1, sub-entry identifier 0011 is obtained in the primary search shown in FIG. 6, as explained earlier.

Also, as a result of the primary search, the sub-entry identifier 0001 is obtained for the IP destination address 10.2.1.1 of the incoming packet.

Similarly, as for the IP protocol, the sub-entry identifier 1001 is obtained as a result of the primary search.

As for the source port number, the sub-entry identifier 0110 is obtained as a result of the primary search.

Further, as for the destination port number, the sub-entry identifier 0101 is obtained as a result of the primary search.

Accordingly, in table 221 of secondary search function section 22, any field values correspond to the second data of the filtering entry values. Thus the entry identifier ‘2’ is obtained.

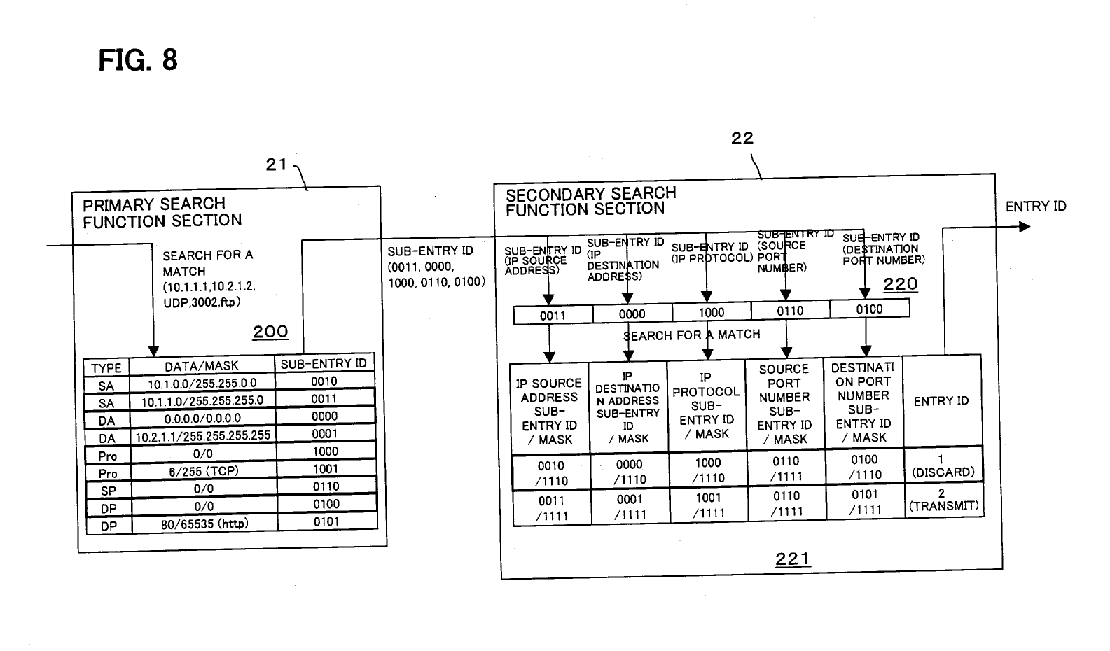

FIG. 8 shows another example in the configuration shown in FIG. 6, where the IP destination address of the incoming packet is 10.2.1.2, the IP protocol is UDP, the source port number is 3002, and the destination port number is ‘ftp’.

In this example, as a result of the primary search for the IP source address of the incoming packet performed in primary search function section 21, the sub-entry identifier 0011 identical to the example shown in FIG. 6 is obtained. Meanwhile, as a result of the primary search for the IP destination address 10.2.1.2, the sub-entry identifier 0000 is obtained

Also, for the IP protocol, the sub-entry identifier 1000 is obtained as a result of the primary search.

For the source port number, the sub-entry identifier 0110 is obtained as a result of the primary search, which is identical to the example shown in FIG. 6. Further, for the destination port number, the sub-entry identifier 0100 is obtained.

In this example, in table 220 of secondary search function section 22, entire field values excluding the IP source address field match the first filtering entry values. In other words, the entire fields do not match an identical filtering entry, as contrasted with the example shown in FIG. 6 in which the entire fields match the second entry.

However, as for the sub-entry identifier 0011 for the IP source address of the incoming packet, this also matches the first filtering entry value. As a result, in the example shown in FIG. 8, the mask in the secondary search causes to match the first entry, and thus the entry identifier ‘1’ is obtained.

In addition, in FIG. 8, when the IP source address of the packet is, for example, 10.1.2.1, the sub-entry identifier 0010 is obtained in primary search function section 21. This matches the first entry in the secondary search. Therefore, also in this case, the entry identifier ‘1’ is obtained.

In the above-mentioned examples shown in FIGS. 6 and 8, primary search function section 21 has a configuration performing a sequential search for each sub-field. However, it is also possible to implement a plurality of primary search function sections each provided for each sub-field, enabling concurrent searches for the respective fields.

Also, according to the above explanation, secondary search function section 22 is structured independently from primary search function section 21. However, it is also possible to configure a search function section with an integral structure, which is also applicable to the embodiments described below.

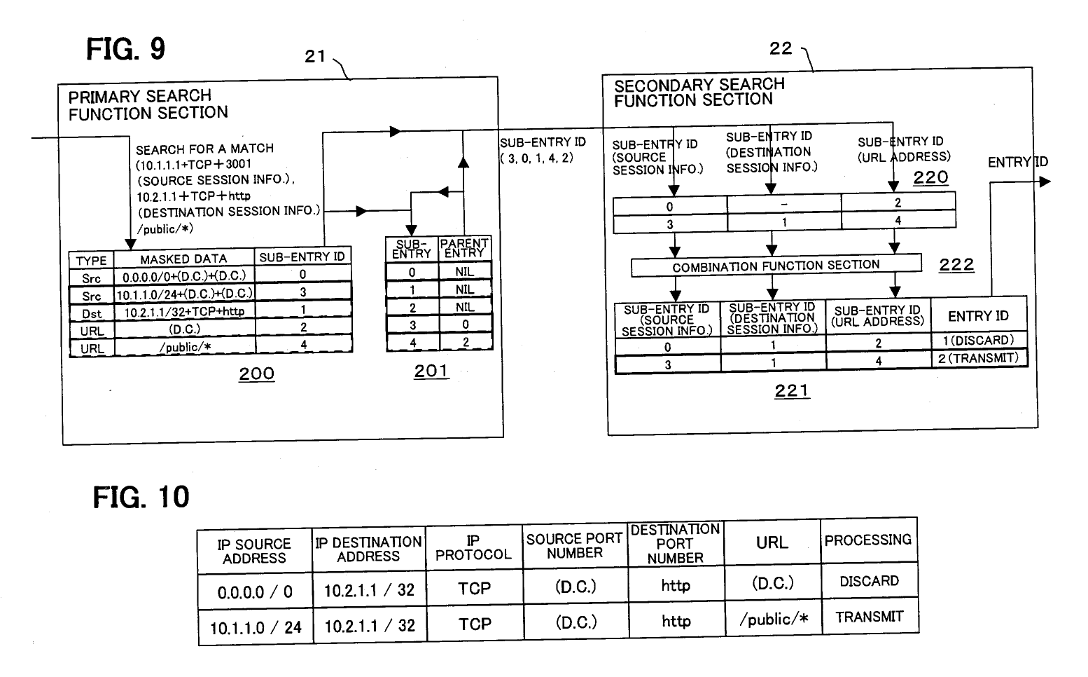

FIG. 9 shows an example of primary search function section 21 and secondary search function section 22 in the second embodiment of the present invention.

In this example, a masked search i.e. a search combined with a mask is featured in primary search function section 21, while an exact-match search is featured in secondary search function section 22.

In primary search function section 21, a first table 200 includes sub-fields for searching each constituted of the combination of IP source address, IP protocol field and TCP/UDP source port number (that is, source session information: Src), the combination of IP destination address, IP protocol field and TCP/UDP destination port number (destination session information: Dst), and the HTTP/URL address (URL).

Also, in primary search function section 21, there is provided a pointer table 201 in which parent entries indicating sub-entry identifiers each having data corresponding to each sub-field are stored.

Secondary search function section 22 has a search function for the combination of the sub-entry identifiers obtained by the primary search.

In FIG. 10, there is shown an example of process settings against an incoming packet in the configuration shown in FIG. 9. Based on this example, the corresponding registration contents in table 200 of primary search function section 21 are shown in the example of FIG. 9.

In FIG. 9, on receiving an incoming packet which matches the second filtering entry in table 200 of primary search function section 21, the sub-entry identifier ‘3’ is obtained as a result of the search for a match with the source session information.

Next, pointer table 201 is searched using this sub-entry identifier ‘3’, which results in obtaining the sub-entry identifier ‘0’ of the parent entry.

These results are forwarded to secondary search function section 22 in order of ‘3, 0’ as a source entry identifier, and are stored into the corresponding registers 220.

Also in primary search function section 21, the search for a match with the destination session information and the search with the URL address are performed in the same way as described above. Using the sub-entry identifiers thus obtained in primary search function section 21, the sub-entry identifiers ‘1’ and ‘4, 2’ are respectively obtained using pointer table 201. These results are forwarded to secondary search function section 22 and stored into the corresponding registers 220.

In secondary search function section 22, there is provided a combination function section 222 in which the contents of registers 220 are combined. Here, arbitrary combinations of sub-entries obtained in the above procedure, namely ‘3, 1, 4’, ‘3, 1, 2’, ‘0, 1, 4’ and ‘0, 1, 2’, are generated.

Thereafter, a search for a match with each of these combinations is performed using table 221. Among the matched results, the entry identifier having the highest priority is selected as an effective entry identifier.

More specifically, in the example shown in FIG. 9, the first entry and the second entry, namely the combinations of ‘0, 1, 2’ and ‘3, 1, 4’, are matched among arbitrary combinations of the sub-entry identifiers. Here, only one matched entry that meets a certain predetermined condition is selected. For example, a matched entry having the deepest matching depth (or the matching field length is the longest) is selected. (In the example of FIG. 9, an entry having higher priority is aligned in a lower position.) Accordingly, because the combination of ‘3, 1, 4’ has the highest priority, the corresponding entry identifier ‘2’ (transmission processing) is obtained.

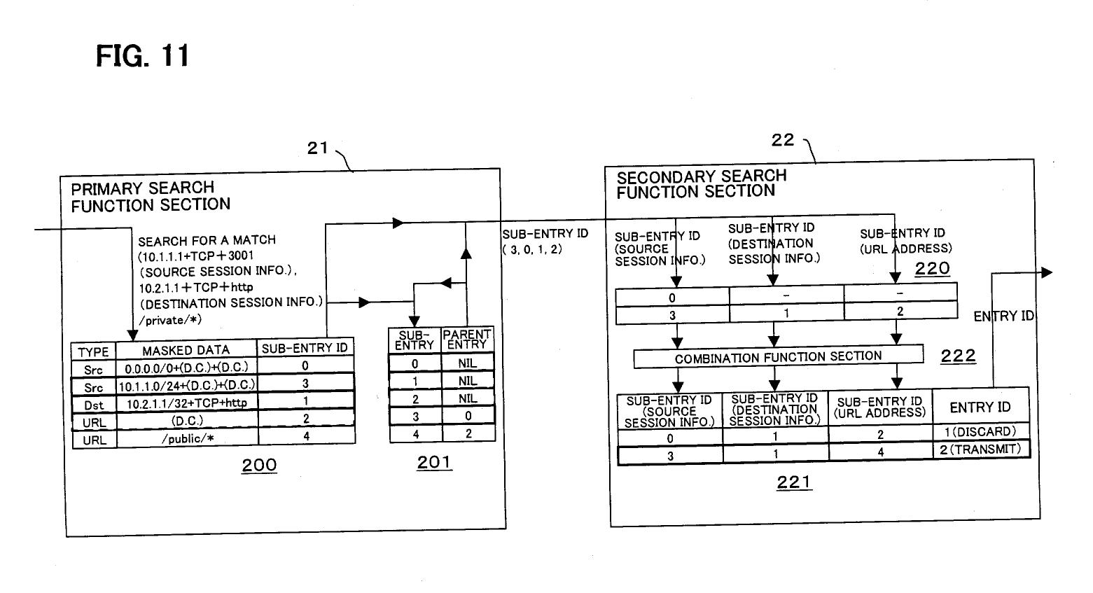

In FIG. 11, there is shown another example of the embodiment, in which only URL of the incoming packet, /private/*, is different from the example shown in FIG. 9. In this example shown in FIG. 11, the sub-entry identifiers obtained from primary search function section 21 are ‘3, 0’, ‘1’, and ‘2’. Accordingly, in combination function section 222 of secondary search function section 22, the combinations of ‘3, 1, 2’ and ‘0, 1, 2’ are obtained.

In this example, only the first entry in table 221 is matched. Therefore, the corresponding entry identifier ‘1’ is chosen, and thus the corresponding filtering entry is determined.

Here, also in the second embodiment, the primary search function section has a configuration that each search field is sequentially searched and each sub-entry is obtained for each field. However, it is also possible to configure each primary search mechanism being provided for each field, and perform concurrent search for each field.

Here, in the examples shown in FIGS. 9, 11 of the second embodiment, secondary search function section 22 is shown as being constituted independently. However, it is possible to configure secondary search function section 22 integrally with primary search function section 21. Also, according to the above description, pointer table 201 is provided in primary search function section 21, and the entire results obtained therein are stored into registers 220 of secondary search function section 22. However, it is also possible to allocate table 201 in secondary search function section 22, and to generate arbitrary combinations of possible sub-entry identifiers while combination function section 222 is making access to pointer table 201.

Now, as a third embodiment of the present invention, an example of a search function for the L4 load balancing will be described hereafter.

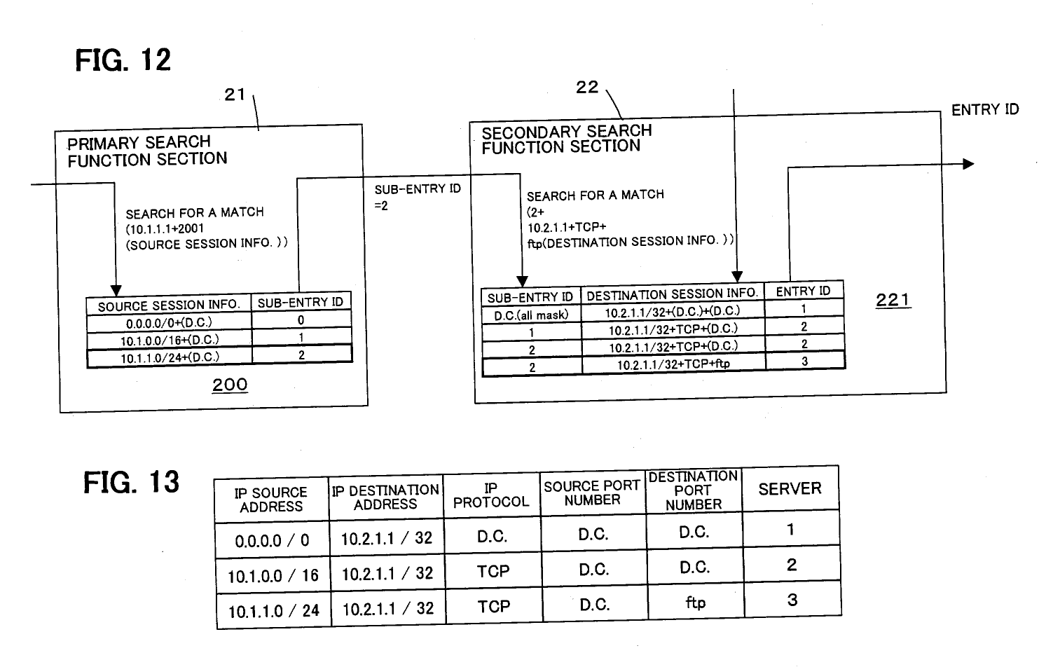

FIG. 12 shows an embodiment using the search function for the L4 load balancing. Here, primary search function section 21 is provided with a masked search function using the combination of the IP source address and the TCP/UDP source port number (source session information).

Also, secondary search function section 22 is provided with a masked search function using the sub-entry identifier obtained by primary search function section 21 and the combination of remainder fields, namely the combination of IP destination address, IP protocol and TCP/UDP destination port number (destination session information).

The operation of the embodiment shown in FIG. 12 will be explained hereafter using the example of setting search entries shown in FIG. 13.

In primary search function section 21, source session information sets each consisting of the combination of an IP source address and a source port number, as well as sub-entry identifiers each corresponding thereto, are set in table 200, corresponding to respective load balancing entries.

Also, in secondary search function section 22, there are set the sub-entry identifiers specified in primary search function section 21 and destination session information sets each consisting of the combination including an IP destination address, corresponding to respective load balancing entries.

Further, in the example shown in FIG. 12, when setting table 200 of primary search function section 21, the third entry has an inclusion relation with the second entry in respect to the source session information. For this reason, in table 221 of secondary search function section 22, an entry consisting of the combination of the sub-entry identifier ‘2’ for the third source session information in table 200 and the second destination session information of the load balancing entry is additionally set. This corresponds to the third entry in table 221 of secondary search function section 22.

Moreover, the first entry in primary search function section 21 (which has the sub-entry ‘0’) matches any values of the source session information field (in other words, the first entry is a default entry). Corresponding to this, the sub-entry identifier field in secondary search function section 22 is set as D.C. (which means any values match) which corresponds to the first entry in table 221 of secondary search function section 22. In such a case, an entry having the combination of other destination session information is not set.

Under the setting condition mentioned above, when a packet corresponding to the third load balancing entry shown in FIG. 13 is input, primary search function section 21 searches for the source session information and outputs the sub-entry identifier ‘2’ corresponding to the third entry. Next, through the search in secondary search function section 22, the entry corresponding to the fourth load balancing entry is matched, and as a result entry identifier ‘3’ is output.

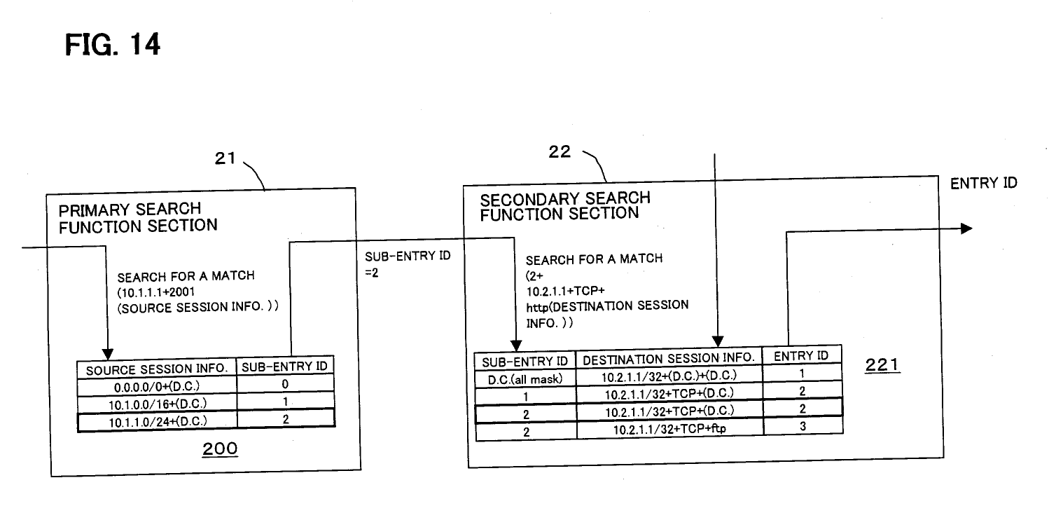

In the third embodiment shown in FIG. 14, the destination session information has a destination port number ‘http’ different from the case in the embodiment shown in FIG. 12, while the source session information is identical to the case in the embodiment shown in FIG. 12.

In this case, the sub-entry identifier ‘2’, which is identical to the embodiment shown in FIG. 12, is output from primary search function section 21. Meanwhile, in secondary search function section 22, a match with the third load balancing entry is obtained, which is set from the combination of the third source session information and the second destination session information, and as a result the entry identifier ‘2’ is output.

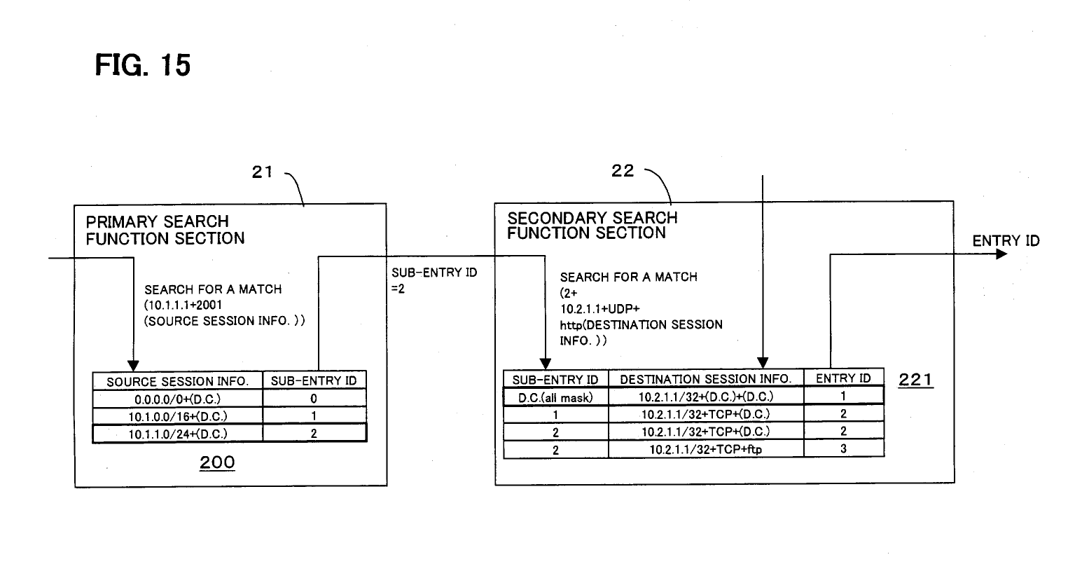

Further, in FIG. 15, there is shown a diagram illustrating an operation when a packet having an IP protocol in the destination session information different from the cases shown in FIGS. 12 and 14 is input, while the source session information in the input packet is identical to these cases of FIGS. 12 and 14, toward a load balancing entry which includes an arbitrary value D.C. in the IP protocol.

Also in this example, the sub-entry identifier ‘2’ is output from primary search function section 21. However, because the destination session information is different from either the third entry or the fourth entry of table 221 in secondary search function section 22, these entries do not match. In this case, because the destination session information matches the first entry of table 221 having an arbitrary value D.C. of sub-entry identifier, the first entry identifier ‘1’ is obtained.

Here, the two-stage configuration consisting of primary search function section 21 and secondary search function section 22 has been shown also in the aforementioned third embodiment to which the method of the present invention is applied. However, it is also possible to introduce a search function configuration consisting of an arbitrary number of stages.

Also, in the configurations shown in FIGS. 12-15, primary search function section 21 and secondary search function section 22 having independent configuration have been shown. However, it is also possible to combine them into a single search function section for common use. Moreover, according to the configuration described above, a default entry of source session information is set in table 200 of primary search function section 21. However, instead of this setting, another configuration is also applicable, such that a default value is given when a match is not obtained in the search.

As the embodiments having been described, according to the present invention, a fast masked search for data having arbitrary length can be achieved using a plurality of fixed-length masked search function sections.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A packet address search method comprising the steps of:
dividing a search field in a packet into a plurality of sub-fields each being searchable at one time;
performing a masked search for a match with each sub-field, and obtaining matched sub-entry identifiers as a primary search;
generating a combination of the plurality of sub-entry identifiers obtained by the primary search; and
performing a search for a match with the combination of the plurality of sub-entry identifiers and obtaining an entry identifier as a secondary search.

2. A packet address search method comprising the steps of:
performing a masked search for a match with each sub-field searchable at one time in a packet search field, and obtaining matched sub-entry identifiers as a primary search; and
performing a masked search for a match with a combination of both the sub-entry identifiers obtained in the primary search and at least a remainder portion of the packet search field, and obtaining an entry identifier as a secondary search.

3. The packet address search method according to claim 1 or 2,
wherein when an inclusion relation exists between each field in the primary search, like sub-entry identifiers are set in advance so as to obtain in the masked search a match with each field having the inclusion relation.

4. The packet address search method according to claim 1 or 2,
wherein when an inclusion relation exists between each field in the primary search, sub-entry identifiers are set in advance so that one sub-entry identifier of an entry having the inclusion relation can be obtained from another sub-entry identifier obtained in the masked search, and
in the secondary search, a search is performed, searching for a match with each of the entire combinations of sub-entry identifiers obtained in the primary search.

5. The packet address search method according to claim 2,
wherein, in the primary search, a masked search is performed, searching for a match with source session information having a combination of an IP source address and a TCP/UDP source port number, and
in the secondary search, a masked search is performed, searching for a match with the sub-entry identifier obtained from the primary search and destination session information having a combination of the remainder fields including an IP destination address, an IP protocol and a TCP/UDP destination port number.

6. A packet address search system comprising:
a primary search function section which divides a search field in a packet into a plurality of sub-fields each being searchable at one time, performs a masked search for a match with each sub-field, and obtains matched sub-entry identifiers;
a secondary search function section which performs a search for a match with a combination of the plurality of sub-entry identifiers obtained in the primary search function section, and obtains an entry identifier.

7. A packet address search system comprising:
a primary search function section which performs a masked search for a match with each sub-field-searchable at one time in a packet search field, and obtains matched sub-entry identifiers as a primary search; and
a secondly search function section which obtains an entry identifier by performing a masked search for a match with a combination of both the sub-entry identifiers obtained in the primary search function section and at least a remainder portion of the packet search field.

8. The packet address search system according to claim 6 or 7,
wherein when an inclusion relation exists between each field in the primary search function section, like sub-entry identifiers are set in advance so as to obtain a match with each field having the inclusion relation in the masked search.

9. The packet address search system according to claim 6 or 7,
wherein when an inclusion relation exists between each field in the primary search function section, sub-entry identifiers are set in advance so that one sub-entry identifier of an entry having the inclusion relation can be obtained from the sub-entry identifier obtained in the primary search, and
in the secondary search function section, a search is performed, searching for a match with each of the entire combinations of sub-entry identifiers obtained in the primary search function section.

10. The packet address search system according to claim 6 or 7,
wherein, in the primary search function section, a masked search is performed, searching for a match with source session information consisting of a combination of an IP source address and a TCP/UDP source port number, and
in the secondary search function section, a masked search is performed, searching for a match with both the sub-entry identifier obtained from the primary search and destination session information consisting of a combination of the remainder fields including an IP destination address, an IP protocol and a TCP/UDP destination port number.

11. The packet address search method according to claim 1 or 2,
wherein when an inclusion relation exists between each field in the primary search, sub-entry identifiers are set in advance so that one sub-identifier of an including entry can be obtained from the other included entry, and
a matched entry identifier is obtained by a search for a match with the entire combinations of the obtained sub-entry identifiers.

12. The packet address search method according to claim 11,
wherein when a field set having no relation with the entry exists, the entry is set in the primary search for a sub-entry identifier so as to mask the field set.
